(19) United States
(12) Patent Application Publication
(10) Pub. No.: US 2026/0346214 A1
(43) Pub. Date: Nov. 5, 2026

(54) CELL FOR THE DEGRADATION (REDUCTION) OF FATS AND DERIVATES

(71) Applicant: PIKA RESEARCH ARASTIRMA GELISTIRME TEKNOLOJI IMALAT LTD.STI., Kocaeli (TR)

(72) Inventor: Aytekin ALPAY, Kocaeli (TR)

(73) Assignee: PIKA RESEARCH ARASTIRMA GELISTIRME TEKNOLOJI IMALAT LTD.STI., Kocaeli (TR)

(21) Appl. No.: 19/488,864

(22) PCT Filed: May 31, 2024
(86) PCT No.: PCT/TR2024/050575

§ 371 Date: Dec. 1, 2025

(30) Foreign Application Priority Data
May 31, 2023 (WO) PCT/TR2023/050492

(51) Int. Cl. B01F 23/41; B01F 25/432

(52) U.S. Cl. CPC B01F 23/41; B01F 25/4321

(57) ABSTRACT

A cell provides the maximum reduction of the paraffin particles to nano sizes contained in the paraffin emulsion within the paraffin degradation tubes generally designed for the degradation of paraffin particles in the emulsion liquid, various fats particle in the emulsion liquid and particles of their derivatives in the emulsion liquid into small nano particles, and the coating of the outer surfaces of the paraffin particles with emulsifier also coating of the outer surfaces of the various fats particles and their derivative particles with emulsifier.

### CROSS REFERENCE TO THE RELATED APPLICATIONS

This application is the national phase entry of International Application No. PCT/TR2024/050575, filed on May 31, 2024, which is based upon and claims priority to International Application No. PCT/TR2023/050492, filed on May 31, 2023, the entire contents of which are incorporated herein by reference.

### TECHNICAL FIELD

The invention generally relates to a paraffin emulsion degradation cell designed for the disintegration of paraffin emulsion, emulsions of various fats and their derivatives into small nano particles and contained in degradation tubes.

### BACKGROUND

Paraffin is a colorless and odorless type of wax obtained from petroleum. It is obtained from wood tar and petroleum. Today, synthetic paraffin wax is also produced.

Paraffin has a wide usage area in industry and is widely used especially in the wood, paper, food, and cosmetics sectors. This wide usage area requires paraffin to be processed into different shapes and sizes. Reducing paraffin sizes is carried out with the purpose of making it more suitable for certain applications. In industry, the process of reducing paraffin sizes is done using various methods.

These are;
Micronization; the process of reducing solids down to micron sizes. Paraffin is reduced to micron sizes using grinding machines or jet mills in the micronization process. This process increases the surface area of the paraffin particles, resulting in a more homogeneous and fine distribution. Micronized paraffin is used in paper coatings, cosmetic products, and some special chemical applications. With the micronization method, paraffin particles can usually be reduced to a size of 1 to 10 micrometers (μm). By using advanced technologies and optimized processes, these sizes can be further reduced to nanosizes (approximately up to 100 nanometers (nm)).
Granulation; the process of converting powdered materials into granular form. Paraffin is converted into granules under a certain humidity and pressure in granulation machines. This process makes the paraffin more easily transportable and treatable. Granular paraffin is widely used in areas such as candle production, paper coating and waterproofing applications. The granulation process converts paraffin into granule form, and typically granule sizes range from 0.2 to 4 millimeters (mm). Granulation does not provide micron or nano level reduction, but rather creates particles at the macro level.
Pulverization; the process of reducing solids into very small particles. Paraffin is ground into a fine powder using pulverization machines. In particular, this process increases the solubility and surface activity of paraffin. Pulverized paraffin is used in coating agents, lubricants, and certain plastics applications. Paraffin particles obtained by the pulverization method are usually in the range of 10 to 100 micrometers (μm). Advanced pulverization techniques can be used to obtain finer particles, however this method may not provide sizes as small as in micronization.
Melting and spray drying; the process of melting solids and drying them by spraying in fine droplets. The paraffin is melted and sprayed in fine droplets through a spray head. These droplets quickly solidify by contact with air and form small particles. Paraffin particles obtained by spray drying method can be used in cosmetic products and pharmaceutical formulations. With the melting and spray drying method, paraffin particles can usually be obtained with a size of 1 to 50 micrometres (μm). In this method, the particle size can be controlled depending on the size of the sprayed droplets and the drying speed. With advanced spray drying technologies, it may be possible to obtain smaller particles (close to nanosizes).

High Pressure Homogenizers are required for better mixing of beeswax emulsions. Paraffin wax does not mix with water, making it difficult to form emulsions. A certain degree of mixing can be achieved using a surfactant, but the most effective mixing can be achieved with high-pressure homogenizers that outperform conventional mixing methods. In the high-pressure homogenizer, the particles are degraded by the effect of shear force and turbulence, and a homogeneous mixture is obtained. As a result of high-pressure homogenization, particles can be reduced to submicron levels. The particle sizes obtained with homogenizers available today are 1-100 μm sizes.

In Patent No. GB1383471A, the preparation of an aqueous paraffin wax emulsion involves emulsifying the wax in water under turbulent flow conditions in the presence of an emulsion igniter and liquid.

Patent No. EP3291012A1 relates to methods involving grinding a wax into wax fragments with a size in the range of about 600 microns to about 800 microns which forms a mixture of wax fragments with water and a surfactant and homogenizing the mixture, and is a wax dispersion in which the homogenization stage is kept below about 35 °C. Said wax dispersion is prepared for use in toners and degraded with a specially designed blade.

### SUMMARY

Said invention is related to preferably paraffin emulsion degradation cell, which has been developed to reduce (degrade) the size of paraffin emulsion particles which are in the state of the art and are used particularly in wood coating, as well as the emulsion particle sizes of various fats and derivatives thereof.

Paraffin emulsion degradation methods included in the state of the art are formed by way of homogenization, and degradation can be done up to a certain size. This leads to the application of paraffin emulsion used at a certain thickness and high amounts, and as a result, causes high costs.

The smaller the paraffin particles in the paraffin emulsion can be reduced, the thinner the layer to be applied, which significantly reduces production costs and therefore user costs.

Especially when considered in the field of coating wood materials, coating with large paraffin particles in paraffin emulsion appears to be used in very high tonnages and increases the costs at the same rate.

With the degradation cell of the invention, paraffin is supplied from one end of the cell under a certain pressure and temperature, and cavitation is created by means of the structuring in the cell, and with the cavitation obtained, the paraffin particles (fragments) in the emulsion are degraded to very small sizes, even reducing below the sizes specified in the state of the art. This creates a significant difference of coating area in the surface area coated with paraffin emulsion particles of different sizes with the same weight.

### Objectives of the Invention

The main object of the invention is to degrade the paraffin emulsion by passing it through the paraffin degradation cell under certain temperature and pressure.

Another object of the invention is to degrade the particle size of emulsions of various fats and emulsions of their derivatives thereof by passing them through the same degradation cell the same way it degrades the particle size of paraffin emulsion.

Another object of the invention is to form the maximum surface coating with minimum thickness by reducing (degrading) the paraffin emulsion fragments.

Another object of the invention is to provide the degradation of the paraffin emulsion by means of the structuring in the paraffin emulsion degradation cell.

An object of the invention is to degrade paraffin emulsion particles without the use of any other additional chemicals.

By using an additional chemical, with an emulsifier, fatty acids, preferably stearic acid, can be coated around the paraffin with an emulsifier while inside the cell.

Another object of the invention is to degrade the paraffin emulsion particles homogeneously in nanosizes.

Another object of the invention is to degrade the paraffin emulsion without using the conventional homogenization method.

### BRIEF DESCRIPTION OF THE DRAWINGS

The embodiments of the present invention, briefly summarized above and discussed in more detail below, can be understood with reference to the example embodiments of the invention described in the accompanying drawings. It should be noted, however, that the accompanying drawings only illustrate typical embodiments of this invention and therefore they are not meant to limit the scope of the invention, as other equally effective embodiments may be allowed.

FIG. 1—Paraffin emulsion degradation cell entrance-exit port view

FIG. 2—Paraffin emulsion degradation cell perspective view

FIG. 3—Paraffin emulsion degradation cell A-B cross-section view

FIG. 4—Paraffin emulsion degradation cell C-D cross-section view

FIG. 5—Paraffin emulsion degradation cell front view

FIG. 6—Paraffin emulsion degradation cell back view

FIG. 7—Paraffin emulsion degradation cell left side

FIG. 8—Paraffin emulsion degradation cell right side

FIG. 9—Paraffin emulsion degradation cell top view

FIG. 10—Paraffin emulsion degradation cell right side left top view

FIG. 11—Paraffin emulsion degradation cell right side right top view

FIG. 12—Paraffin emulsion degradation cell left side right top view

FIG. 13—Graph of intracellular paraffin emulsion flow lines

FIG. 14—Graph of the formation of vortices when viewed from a cross-section of the cell

FIG. 15—Graph of change of static pressure in the flow through the cell across the cross-section area

FIG. 16—Graph of shear stresses due to flow on cell inner surfaces

FIG. 17—Turbulence intensity graph from the cross-section area of the cell

FIG. 18—Intracellular turbulence viscosity graph

FIG. 19—Intracellular turbulence energy graph

FIG. 20—Intracellular velocity vector graph

FIG. 21—Intracellular vapour volume graph

FIG. 22—Intracellular shear stress graph

FIG. 23—Vortex formation graph of the fluid in contact with the inner surface of the cell

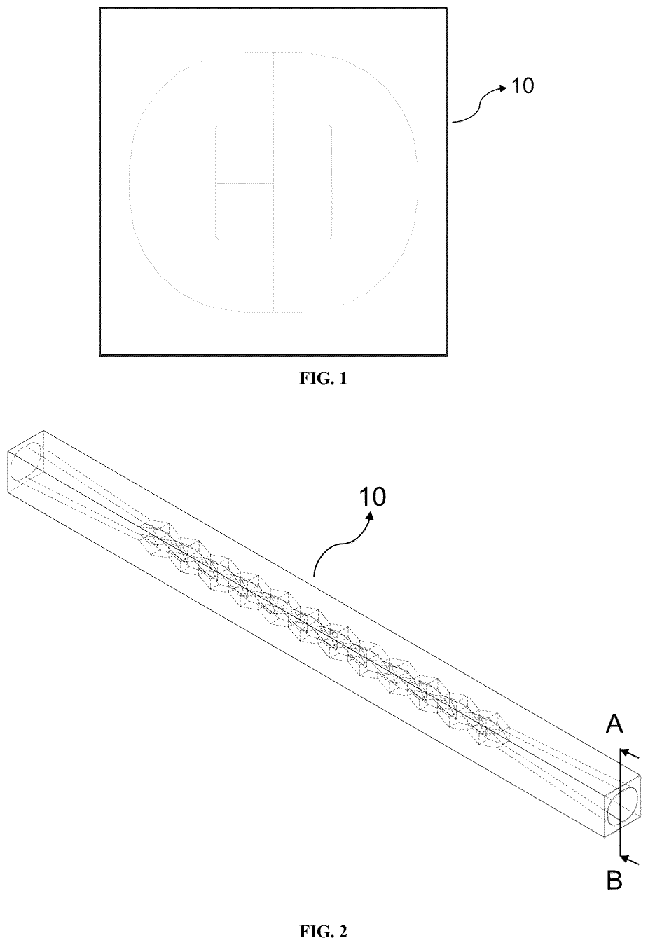

For easier understanding, identical reference numbers are used where possible to indicate identical elements common to the figures. The figures are not drawn to scale and can be simplified for clarity. It is contemplated that the elements and features of an embodiment can be usefully incorporated into other embodiments without further explanation.

### LIST OF REFERENCES

10—Cell
11—Cell upper structure
12—Cell lower structure
20—Cell unit
21—Collusion ramp
22—Landing ramp
23—Lifting ramp
24—Symmetrical wall
25—Asymmetrical wall
30—Paraffin emulsion flow lines
40—Vortex
50—Flow static pressure
60—Shear stress
70—Turbulence intensity
80—Turbulence viscosity
90—Turbulence energy
100—Velocity vector
110—Steam volume
120—Shear stress
130—Vortex of fluid

### DETAILED DESCRIPTION OF THE EMBODIMENTS

In this detailed description, the elements that make up the invention are determined to explain the working principle of the invention, and does not create a limiting effect on the invention. Equivalent elements can also be considered within the scope of the invention.

Unless otherwise stated, the flow direction is from left to right in all drawing details.

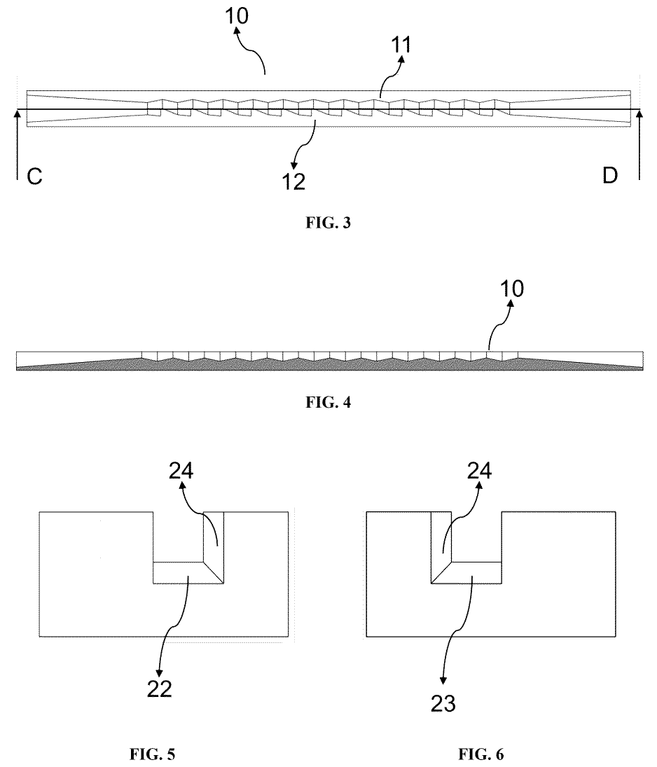

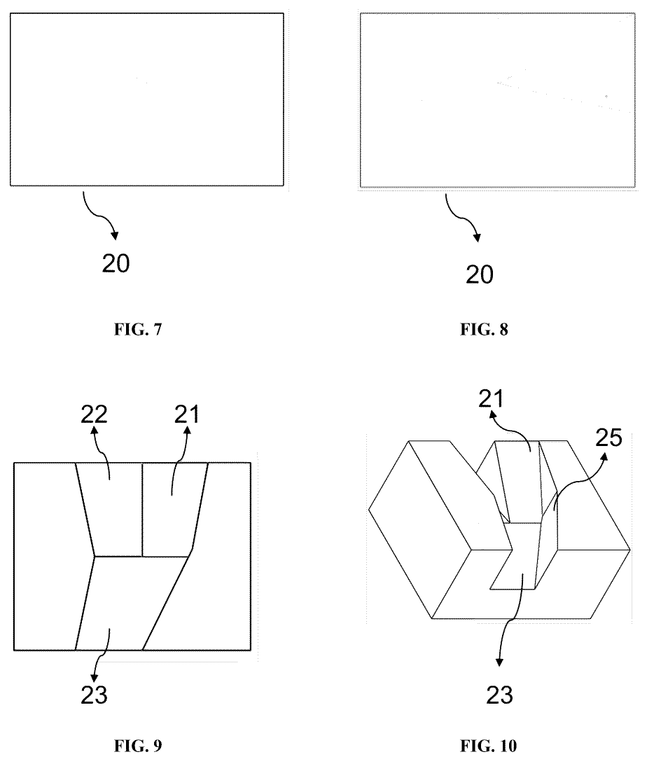

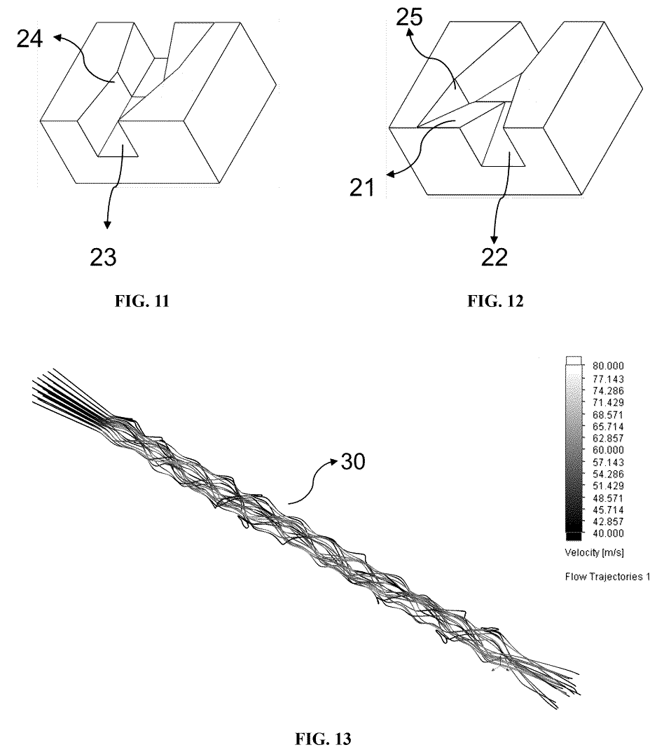

FIG. 3: The C-D cross-section divides the cell (10) into two parts, these parts are defined as the cell upper structure (11) and the cell lower structure (12).

The cell upper structure (11) and the cell lower structure (12) are two identical twin parts. When placed on top of each other, they are positioned opposite each other.

The cell upper structure (11) and the cell lower structure (12) consist of identical/equal cell units (20). The number of these units can be adjusted according to the need and is preferably designed as twelve. Each cell unit (20) consists of, collision ramp (21), landing ramp (22), lifting ramp (23) with an angle between 15-60 degrees, symmetrical wall (24), and asymmetrical wall (25) areas. Among these areas, the collision ramp (21) allows the paraffin emulsion passing through the cell (10) to collide with the top part of the next cell unit (20). The landing ramp (22) allows the paraffin emulsion, which will pass through the cell unit (20) to the next cell unit (20), reach the entrance port of the next cell unit in a downstream direction. The lifting ramp (23) is located at the entrance port of the cell unit (20) and allowing the paraffin emulsion to be lifted to the middle of the cell unit (20) at a certain angle. A symmetrical wall (24) is a structure that is located on one side of the cell unit (20) and converges in the middle of the cell unit (20) and consists of two equal walls. The asymmetrical wall (25) is the surface located opposite to the symmetrical wall (24) of the cell unit (20), consisting of two unequal walls, with one surface as long as the lifting ramp (23) and the other surface as long as the collision ramp (21), and where the peak point of the collision ramp and the peak end point of this surface are equal.

The invention described above reduces the fragment size of the paraffin emulsion at fixed weight, increasing the number of fragments and covering more area.

(For Example: The diameter of a single paraffin particle weighing 1 g is 1.28 cm and an area of 5 cm² is covered with this particle, but when this 1 g paraffin is degraded into more than one particle, 2000 particles with a diameter of 1 mm are obtained, and an area of 65 cm² can be covered with these degraded particles.)

The invention provides for degradation (reduction) of the paraffin emulsion passed through the paraffin emulsion degradation cell by colliding with the structuring in the paraffin emulsion degradation cell through which it is passed at the appropriate heat and pressure conditions at the appropriate velocity.

The invention provides for degradation of the paraffin emulsion which is passed through a paraffin emulsion degradation tube with a certain pressure and heat value with sizes close to each other.

The graph shown in FIG. 13 shows the flow in the cell with twenty different trajectory lines. The flow enters from the left side and exits from the right side. The colorations on these lines express velocities. The dark parts of the lines indicate that the velocity of the fluid following that trajectory decreases a t that point, while the light colored parts indicate the velocity of the fluid following that trajectory is accelerating. In addition, with these trajectories, it is seen what kind of route the fluid in the cell follows. As can be seen from the lines, as the fluid moves along the cell, it also moves circularly within itself and changes places, mixing up at the same time. The ring shape formed by a line itself reveals the existence of the vortex therein and also that there is a backflow, and owing to this backflow, the fluid makes two opposite movements in the same place and collides within itself.

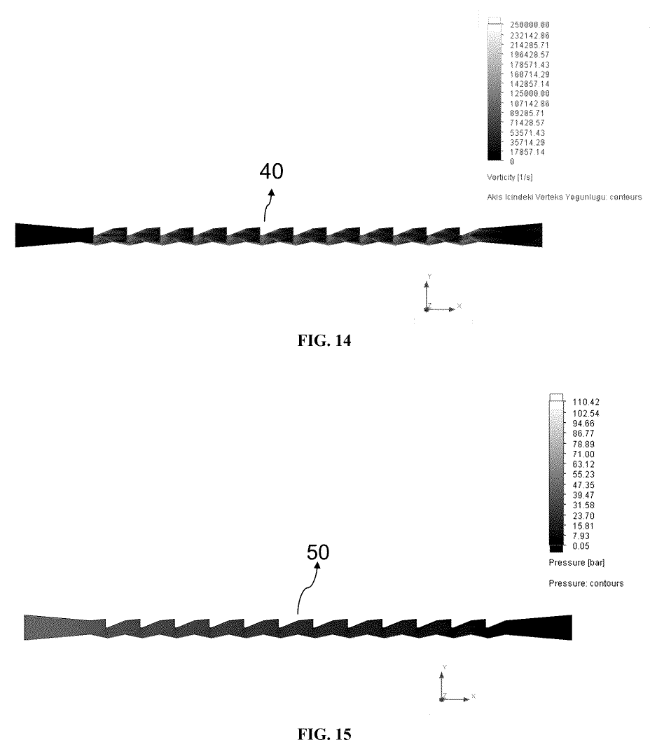

FIG. 14 shows where vortices are formed when viewed from the cross-section area of the paraffin emulsion inside the cell. The vortex density increases from dark to light color. Starting from the side of the threads, it is observed that vortices are formed repeatedly in each thread. In places where there are vortices, mixing is provided in the flow.

FIG. 15 shows the change of the static pressure in the flow through the cross-section area of the paraffin emulsion in the cell. The flow enters from the left and exits from the right. The fluid, which is at high pressure at the cell entrance, loses its pressure as it proceeds. The light color indicates high pressure and the black color indicates low pressure. In addition, it was determined that at the beginning of each thread, there was a pressure drop on the flow perpendicular to the entire axis.

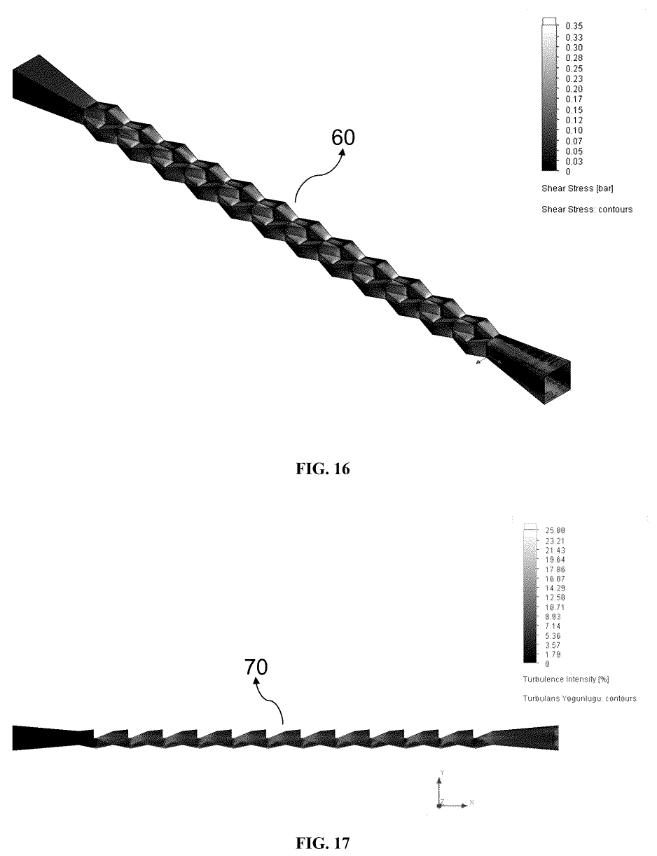

FIG. 16 shows the shear stresses caused by flow on the inner surfaces of the cell unit (20) of the paraffin emulsion inside the cell. The dark color symbolizes low shear stress and the light color symbolizes high shear stress. The flow runs from the top left to the bottom right. Shear stress increases at the sharp edges of the cell were determined. These shear stresses occur in the same amounts in the same places in the fluid, and the paraffin particles are degraded by creating a shear force in the fluid.

FIG. 17 shows an image taken from the cross-section area of the paraffin emulsion inside the cell. The flow runs from the left side to the right side. The dark-colored parts indicate a low turbulence intensity, and the light-colored parts indicate the places where the turbulence is high. The intensity of the turbulence created by the threads in the flow is shown. Immediately after each thread, the flow enters an intense turbulence. While the fluid flows due to turbulence, it also mixes within itself and homogenization is achieved.

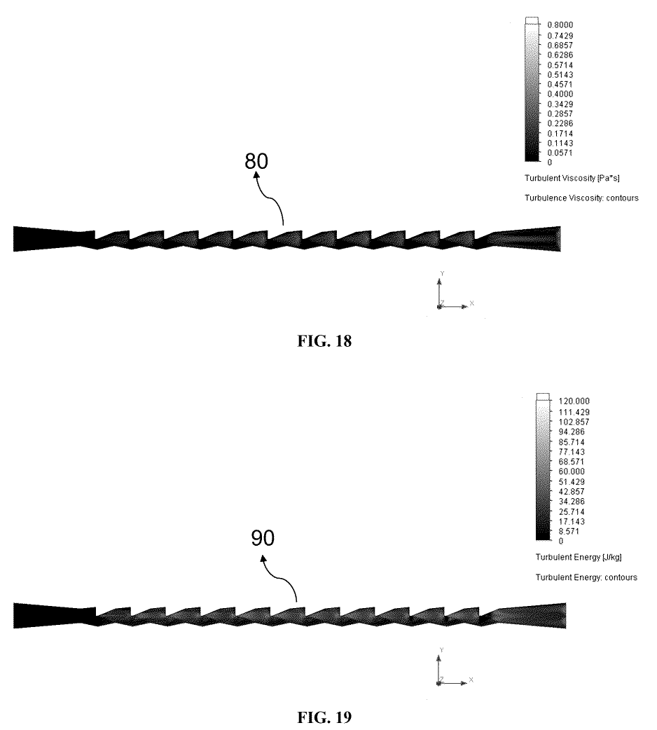

FIG. 18 shows the turbulence viscosity of the paraffin emulsion inside the cell. It shows the viscosity change of the fluid due to turbulence. The flow runs from the left side to the right side.

The black colored parts indicate a low viscosity change, and the white parts indicate a high viscosity change.

FIG. 19 shows the turbulence energy of the paraffin emulsion inside the cell. The parts where the turbulence energy is high and low are expressed, which also show the intensity of the turbulent effect created by the fluid entering turbulence. While the turbulence energy is low in the dark colored parts, there is high energy turbulence in the light colored parts.

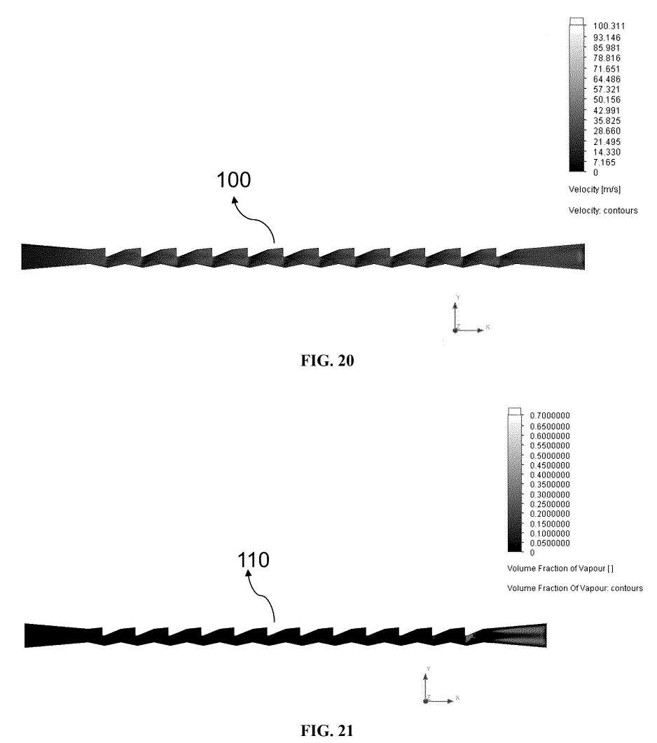

FIG. 20 shows the image of the cross-section area of the paraffin emulsion inside the cell within the cell unit (20), the rate changes of the fluid in the cell are indicated with a black-white contour in the coloring in this cross-section area. While the velocity of flow is low in the dark colored parts, the velocity of flow is high in the light colored parts.

FIG. 21 shows the image of the cell unit (20) cross-section area of the paraffin emulsion inside the cell. The flow enters from the left side and exits from the right side. The dark-colored parts indicate the low vapor volume ratio, and the light-colored parts indicate the high vapor volume ratio. The volume of steam resulting from cavitation behind the threads along with the decreasing vapor pressure as it proceeds towards the exit side is indicated. Increasing vapor volume ratio means increasing cavitation. Cavitation means bursting of bubbles and particle degradation in the fluid. In the last parts, a large part of the degradation effect is achieved with these cavitations.

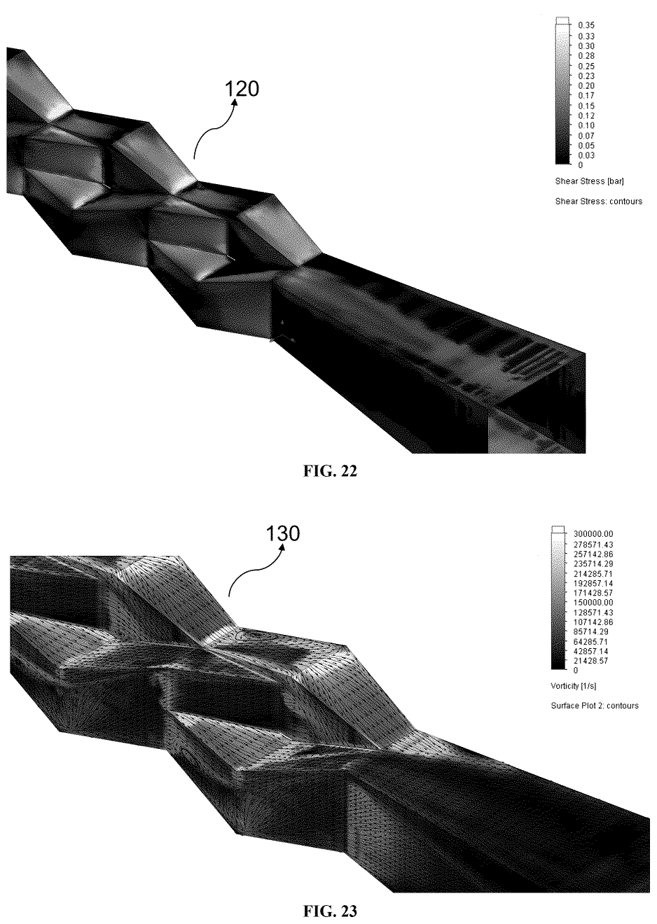

FIG. 22 shows the shear stresses of the paraffin emulsion inside the cell occurring on the surfaces of the cell unit (20). It expresses the same values as FIG. 21 and is a closer (magnified) image.

FIG. 23 shows the amount of vortex formation of the fluid of the paraffin emulsion in the cell in contact with the cell unit (20) surface. The flow comes from the top left and exits from the top right part. Dark colored parts indicate a small amount of vortex formation, while light colored parts indicate a high rate of vortex formation. Also, the lines drawn on the colored parts on the surface indicate the trajectory of the fluid, while the arrows show the direction of the flow. The ring-shaped lines show the size and location of the vortex. With the vortices, the particles in the fluid trying to make a circular movement collide with the particles coming from behind with high velocity, therefore these vortices play an important role in the degradation of the particles in the fluid.

In the paraffin emulsion degradation tube structuring described in detail above, a paraffin emulsion solution with a maximum permeability of 1-100 l//min, preferably 20 l/min at a pressure of 80-150 bar, preferably 100 bar, is passed through a line at a constant flow rate. The paraffin emulsion, which is passed at the appropriate pressure, temperature and velocity, begins to collide with all surfaces of the specially designed geometric form in the structuring, in other words, it collides with the geometric forms that resist the flow.

The paraffin emulsion starting to hit the geometric surfaces formed by turbulence and cavitation which form when the velocity of the flow, temperature, and pressure are combined degrades. This degradation of the paraffin emulsion continues from the entrance port of the other cell unit (20) to the exit port until the end of the cell unit (20), and from the other end to the exit, within all cell units (20) along the cell (20), multiple degradations occur by hitting both the outer wall of the cell unit (20) and the surfaces inside the cell unit. This allows the paraffin emulsion to be degraded (reduced) into very small sizes and to obtain a paraffin emulsion of the desired size. As the number of threads in the paraffin emulsion degradation tube increases, the degradation increases in nanosize. The structuring inside the paraffin emulsion degradation tube preferably has two pairs of micro-structures with a 40 micron titanium coating.

The total length of the structuring in the paraffin emulsion degradation tube of the invention is 10 cm with the entrances. This measure is a preferential measure and may vary according to other condition variables and needs.

There are 12 thread structures over 10 cm, which is the preferential measure, and this thread structure can be located on at least one surface. While the liquid paraffin emulsion is passed in water through the geometric form of these threads, the material is covered with an emulsifier on each thread surface and degradation is achieved.

Degradation is achieved through the turbulence caused by the surface impacts of the fluid and the cavitations created by this turbulence.

During the paraffin degradation (reduction) process, the paraffin surface is coated with surfactants (emulsifier). One of the most important features of the system is the simultaneous degradation of the paraffin and the coating of the paraffin surface with emulsifiers.

Coating the surface of the paraffin with an emulsifier during degradation prevents the paraffin from sticking together.

What is claimed is:

1. A cell for degradation of paraffin emulsion particles, various fats emulsions particles, and particles of their emulsion of derivatives, wherein the cell consists of two identical twin parts, a cell upper structure and a cell lower structure, which are positioned opposite to each other when placed on top of each other.

2. The cell according to claim 1, wherein a number of units is allowed to be adjusted according to a need and preferably comprises twelve cell units.

3. The cell according to claim 2, wherein each cell unit consists of a collision ramp, a landing ramp, a lifting ramp, a symmetrical wall, and an asymmetrical wall.

4. The cell according to claim 3, wherein the collision ramp allows a paraffin emulsion passing through the cell to collide with a top part of a next cell unit.

5. The cell according to claim 3, wherein the landing ramp allows a paraffin emulsion, which will pass through the cell unit to a next cell unit, to reach an entrance port of the next cell unit in a downstream direction.

6. The cell according to claim 3, wherein the lifting ramp is located at an entrance port of the cell unit and allows a paraffin emulsion to be lifted to a middle of the cell unit at 15-60 degrees.

7. The cell according to claim 3, wherein the symmetrical wall is located on a side of the cell unit and converges in a middle of the cell unit and consists of two equal walls.

8. The cell according to claim 3, wherein the asymmetrical wall is located opposite to the symmetrical wall of the cell unit, consists of two unequal walls, with a first surface as long as the lifting ramp and a second surface as long as the collision ramp, and having a surface where a peak point of the collision ramp and a peak end point of the surface are equal.

9. The cell according to claim 1, wherein the cell comprises a cell unit which degrades a paraffin in a paraffin emulsion while also coating the paraffin emulsion particles.

10. The cell according to claim 1, wherein the cell comprises a paraffin emulsion degradation cell unit in which a paraffin emulsion solution with a maximum permeability of 1-100 l/min at a pressure of 1-150 bar is passed through a line at a constant flow rate.

11. The cell according to claim 1, wherein the cell comprises a paraffin emulsion degradation cell unit in which a paraffin emulsion solution at a pressure of preferably 100 bar and with a maximum permeability of preferably 20 l is passed through a line at a constant flow rate.

12. The cell according to claim 1, wherein the cell comprises a paraffin emulsion degradation cell that creates turbulence and/or cavitation when a velocity of a flow, temperature, and pressure are combined.

13. The cell according to claim 1, wherein the cell comprises a paraffin disintegration cell unit which provides degradation through turbulence caused by surface collusions of a fluid and cavitations created by the turbulence.

14. The cell according to claim 1, wherein the cell comprises a paraffin degradation cell unit which degrades a paraffin, while simultaneously allowing a surface thereof to be coated with fatty acids, preferably stearic acid emulsifiers.

15. The cell according to claim 2, wherein the cell comprises a paraffin emulsion degradation cell that creates turbulence and/or cavitation when a velocity of a flow, temperature, and pressure are combined.

16. The cell according to claim 3, wherein the cell comprises a paraffin emulsion degradation cell that creates turbulence and/or cavitation when a velocity of a flow, temperature, and pressure are combined.

17. The cell according to claim 4, wherein the cell comprises a paraffin emulsion degradation cell that creates turbulence and/or cavitation when a velocity of a flow, temperature, and pressure are combined.

18. The cell according to claim 5, wherein the cell comprises a paraffin emulsion degradation cell that creates turbulence and/or cavitation when a velocity of a flow, temperature, and pressure are combined.

19. The cell according to claim 6, wherein the cell comprises a paraffin emulsion degradation cell that creates turbulence and/or cavitation when a velocity of a flow, temperature, and pressure are combined.

20. The cell according to claim 7, wherein the cell comprises a paraffin emulsion degradation cell that creates turbulence and/or cavitation when a velocity of a flow, temperature, and pressure are combined.
